(19) United States
(12) Patent Application Publication
(10) Pub. No.: US 2007/0193543 A1
(43) Pub. Date: Aug. 23, 2007

(54) VALVE DEACTIVATION DEVICE

(75) Inventor: Richard R. Best, Garden City, MI (US)

Correspondence Address: ARTHUR J. PLANTAMURA;GENERAL CHEMICAL PERFORMANCE PRODUCTS LLC., 90 EAST HALSEY ROAD, PARSIPPANY, NJ, 07054, US

(73) Assignee: Gen Tek Technologies Marketing Inc., Westfield, MI (US)

(21) Appl. No.: 11/675,686

(22) Filed: Feb. 16, 2007

Related U.S. Application Data
(63) Continuation-in-part of application No. 11/060,663, filed on Feb. 17, 2005.
(60) Provisional application No. 60/545,739, filed on Feb. 18, 2004.
(60) Provisional application No. 60/546,692, filed on Feb. 20, 2004.

(51) Int. Cl. F01L 1/34; F01L 1/18; F02D 17/02

(52) U.S. Cl. 123/90.39; 123/198 F; 123/90.16

(57) ABSTRACT

A valve deactivation device for a rocker arm assembly having a cam arm and a valve arm is provided. A return spring biases a locking latch pin toward an activated position to allow the cam arm and the valve arm to rotate together. The latch pin can be translated against the biasing force of the return spring to decouple the cam arm and valve arm for relative rotation. The latch pin and the latch pin housing are adjusted so as to limit the clearance between them and mate the latch pin and the latch housing. The cam follower and the actuator section of the rocker arm are mounted on, and are not independent of, the rocker shaft. Clearances between parts are controlled such that their relative rotation is strictly limited in the selective engagement of the latch pin in one section and latch pin receiving hole in the other section.

### CROSS REFERENCE TO RELATED APPLICATIONS

This application is a Continuation-in-Part of U.S. application Ser. No. 11/060,663 filed on Feb. 17, 2005; which claims the benefit of U.S. Provisional Application Ser. No. 60/545,739, filed on Feb. 18, 2004, and U.S. Provisional Application Ser. No. 60/546,692, filed on Feb. 20, 2004, the contents of which are incorporated in their entireties by reference.

### FIELD OF THE INVENTION

The present invention relates to valve trains for internal combustion engines. More particularly, the present invention relates to an improved valve deactivation device for use in a valve train for internal combustion engines.

### BACKGROUND OF THE INVENTION

Modern multi-cylinder internal combustion engines include a valve train having intake and exhaust valves disposed in the cylinder head above each combustion cylinder. The intake and exhaust valves connect intake and exhaust ports with each combustion cylinder. The intake and exhaust valves are generally poppet-type valves having a generally mushroom-shaped head and a elongated cylindrical stem extending from the valve head. A spring biases the valve head in a fully closed position against a valve seat in the cylinder head. Historically, engine valves were actuated from the fully closed position to a fully open position by a underhead camshaft, pushrod, and rocker arm assembly. Hydraulic lifters, which utilize pressurized hydraulic fluid to actuate a piston to reciprocate the valve, were added between the motion of the rocker arm and the valve stem as a means for adjusting valve lash. In later developments, overhead camshafts eliminated the pushrod and, occasionally, the rocker arm for a more direct actuation of the valves.

Reduction of fuel consumption and improved emissions, especially for passenger cars, have been important considerations for internal combustion engine design. One engine design change for reducing fuel consumption and improving emissions has been a shutdown of individual cylinders during engine operation, especially during partial load. A cylinder shutdown increases intake manifold pressure thereby allowing the remaining cylinders to operate at increased average pressure and thus have a reduced specific consumption. For cylinder shutdown, it is not only necessary to provide for an interruption of the fuel supply, it is furthermore expedient to interrupt the load flow through the respective cylinder by shutting down one or more valves, especially the intake valve of the respective cylinder.

Valve deactivation devices have been employed to shut down valves in an operating engine. When valves are deactivated, friction losses in the valve train are reduced. Many prior art valve deactivation devices undesirably include numerous components that make the devices costly to produce and assemble. Still other prior art devices operate by decoupling components of rocker arms that may not necessarily realign properly in order to recouple and reactivate the rocker arm. Other valve deactivation devices, because of their configuration, are not capable of providing the needed structure to provide suitable tolerances in mating of parts to provide proper function and avoid objectionable noisy operation and unacceptable wear in modern high efficient engines. For example, the valve activator of the cam mechanism for internal combustion engines described in the Lotus Cars Limited UK Patent Application GB2,333,322A, published Jul. 21, 1999, lacks the necessary prerequisites of providing measured, selectively sorted and mated (and not interchangeable) specifications to provide necessary clearances for the desired engine performance efficiency.

The present invention provides a needed improvement in valve deactivation mechanisms involving the mating of non-interchangeable sections that are maintained as a set and comprises a valve deactivation device that permits a rocker arm assembly to deactivate using fewer moving parts than prior art assemblies.

### SUMMARY OF THE INVENTION

The present invention is directed to an improved rocker arm assembly having a valve deactivation device for a valve train. As distinguished from the prior art cam mechanism disclosed in the above referenced UK Patent Application GB 2,333,322A, the cam follower and the valve actuator sections of the rocker arm are independently mounted on the rocker shaft each for free rotation about the rocker shaft. The present invention comprises an arrangement in which the cam follower and valve actuator sections of the rocker arm are not independently mounted on the rocker shaft. In particular the invention comprises three forms, each creating a rocker arm assembly which is in turn mounted on, but not independent of, the rocker shaft for free rotation about it.

In the first form, the valve actuator section and cam follower section are mounted on a tube and secured thereon to create a rocker arm assembly. In the second form, the valve actuator section comprises a tube element onto which the cam follower section is mounted and secured thereon to create a rocker arm assembly. In the third form, the cam follower section comprises a tube element onto which the valve actuator section is mounted and secured thereon to create a rocker arm assembly.

According to the invention, it is necessary that a close control of the lateral clearance between the rocker arm sections and mechanical lash within the valve deactivating device be maintained. The control and mating of the lateral clearance between the rocker arm sections is a prerequisite to ensure adequate engagement of the locking pin within the two rocker arm sections in order to provide adequate locking mechanism durability and overall rocker arm assembly mechanical stiffness.

Referring to the prior art cam mechanism disclosed in the above referenced UK Patent Application GB2,333,322A, the force produced by the springs biasing the locking pins to their normally extended position produces a reaction force which in turn separates the cam follower sections from the valve actuator section. As stated in the above referenced UK Patent Application GB 2,333,322A, while mounted on the rocker shaft, the rocker arm sections are independent of the rocker shaft and free, not only to rotate about it, but also to slide along it. Increasing the lateral clearance between the sections results in a decrease to the engaged length of the locking pins within each section. The above referenced UK Patent Application GB2,333,322A lacks a disclosure of any means to limit the lateral clearance of the rocker arm assembly; this clearance varies considerably due to manufacturing variation of the rocker arm sections and of the cylinder head into which the rocker arm assembly is installed. The present invention overcomes this difficulty by measuring and select-fitting, by shimming, or otherwise adjusting the rocker arm sections to obtain the proper limited lateral clearance i.e. within a variational tolerance, and then by means of the structures described, maintains the rocker arm as a complete (dedicated) assembly which requires no further adjustment of lateral clearance upon installation into an engine.

The control of mechanical lash, the clearance between the lock pin in one section and that of the surface receiving the lock pin in the other section of the rocker arm, is a pre-requisite to providing smooth functioning avoiding objectionable noisy operation and preventing excessive wear. Referring to the prior art cam mechanism disclosed in the above referenced UK Patent Application GB 2,333,322A, a stop is provided on one of the valve actuator and cam follower sections of the rocker arm to define a limit position in which the locking pins align with their mating bores. However, this reference provides no disclosure of any means to limit the mechanical lash or clearance between the locking pins of either cam follower section and of their mating surfaces in the valve actuator section. This clearance can be and often is found to prove considerable and thus excessive due to manufacturing variation of the rocker arm sections, especially with respect to the location of the locking pin bores, piston bores, rocker shaft bores, and the diameter of the locking pins. In addition, because the cam mechanism described in UK Patent Application GB 2,333,322A comprises two separate locking pins, if the mechanical lash at each locking pin is not identical, only one locking pin will engage the mating surface of the locking mechanism with the result that only one of the two locking pins transfers the entire load from the cam follower section to the valve actuator section. This increases the Hertzian contact stress at the locking pin mating surfaces, substantially decreasing the load carrying capacity and durability of the rocker arm assembly.

The present invention overcomes these drawbacks by measuring and select-fitting, shimming, or otherwise adjusting the rocker arm sections to obtain the proper mechanical lash and then by means of the structures described, maintains the integrity of the rocker arm as a complete assembly which requires no further adjustment of mechanical lash upon installation into an engine. As such, the components of the integrated assembly of a finished rocker arm are dedicated, i.e. are not interchangeable with others and must be maintained as a set. The improvements set forth in the present invention precludes the inadvertent interchange of components as is permitted by the prior art cam mechanism disclosed in the above referenced UK Patent Application GB 2,333,322A.

The rocker arm assembly of the valve train may be switchable between an activated condition and a deactivated condition. In one embodiment, the rocker arm assembly includes a valve actuator section, a cam follower section that is rotatably coupled to the valve actuator section, and a valve deactivation device. The valve deactivation device is coupled to the cam follower section. The valve deactivation device includes a lock pin that selectively cooperates with a surface of the valve actuator section to switch the rocker arm assembly to the activated condition. The lock pin is moveable between a deactivated position and a activated position; the activated position corresponding to the valve activated condition, and the deactivated position corresponding to the valve deactivated condition. In another embodiment of the invention, a rocker arm assembly includes a valve actuator section, a cam follower section, and a valve deactivation device. The cam follower section is rotatably coupled to the valve actuator section. The valve actuator section and the cam follower section are rotatable generally about a common axis. The common axis is defined by a rocker shaft. At least a portion of the valve actuator section and at least a portion of the cam follower section are concentrically positioned about the common axis. The valve deactivation device is coupled to the rocker arm assembly to switch the rocker arm assembly between the valve activated condition and a valve deactivated condition. In a further embodiment, a valve deactivation device for a rocker arm assembly includes a hydraulically operated lock pin coupled to the rocker arm assembly and a return spring biasing the lock pin in the activated position. The lock pin selectively engages a surface of the rocker arm assembly to switch the rocker arm assembly to the valve activated condition. The lock pin is movable between a deactivated position and an activated position, the activated position corresponding to the valve activated condition, and the deactivated position corresponding to a valve deactivated condition.

### BRIEF DESCRIPTION OF THE DRAWINGS

FIG. 1 is a perspective view of a valve train assembly.

FIG. 2 is a perspective view of a rocker arm assembly that includes a valve deactivation device in accordance with the present invention.

FIG. 3 is a rear perspective view of the rocker arm assembly of FIG. 2.

FIG. 4 is a side view of the rocker arm assembly of FIG. 2.

FIGS. 5a and 5b are sectional views taken along line 5-5 of FIG. 4 illustrating the valve deactivation device in accordance with the present invention respectively in a valve activated condition and in a valve deactivated condition.

FIG. 6 is a detail view within circle 6 of FIGS. 5a and 5b illustrating the mechanical lash of the deactivation device and the lateral clearance between the cam follower and valve actuator sections of the rocker arm.

### DETAILED DESCRIPTION OF THE INVENTION

In the mechanism of the invention, the cam follower and valve actuator sections of the rocker arm are not independent of the rocker shaft and as noted above comprise three forms, each creating a rocker arm assembly which is in turn mounted on the rocker shaft for free rotation about it.

In the first form, the rocker arm assembly comprises the valve actuator section and cam follower section are mounted on and secured to a tube. In the second form, the valve actuator for the rocker arm assembly is created by a tube element onto which the cam follower section is mounted and secured thereon. In the third form, the cam follower section for the rocker arm assembly comprises a tube element onto which the valve actuator section is mounted and secured thereon.

It is necessary to create a rocker arm providing control of both (a) the lateral clearance between the two rocker arm sections, and (b) the clearance or mechanical lash between the locking pin in one section and the locking pin receiving hole in the other section. As such, the relative free rotation of one section to the other is strictly limited at those times when the locking pin selectively engages its receiving hole, joining the two sections in order to actuate the companion engine valve.

Due to manufacturing variation and because the two clearances identified above must be sufficiently small to ensure proper function to avoid objectionably noisy operation, discrete valve actuator sections and cam follower sections must be measured, sorted, and selected and mated or be shimmed or otherwise adjusted by appropriate means to provide the necessary close tolerance clearances, typically 50-150 μm. As such, the components of a finished rocker arm assembly are dedicated and are not interchangeable with others and must be maintained as a set. The improvements set forth in this invention prevent the inadvertent interchange of components as is permitted by the prior art cam mechanism such as that disclosed in UK Patent Application GB 2,333,322A.

In the alternative second and third embodiment of the invention, the assembly comprises a tube element section onto which the other section is mounted and wherein the tube element is fixedly attached to a rocker arm section, for example by an interference press fit or metallurgical or adhesive bonding.

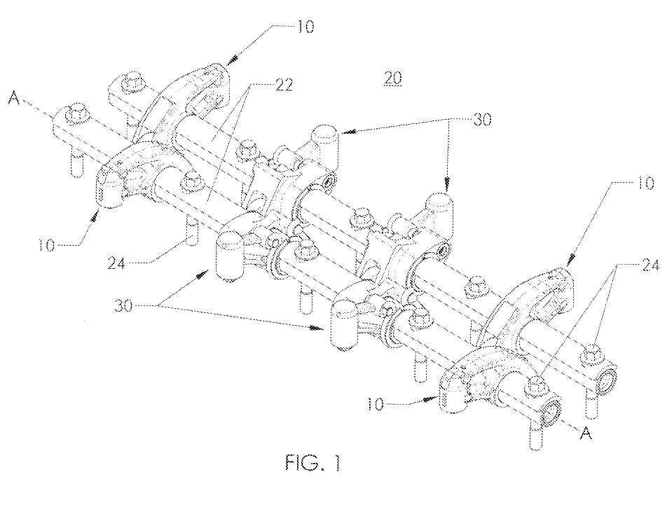

With reference to FIG. 1, a valve train assembly 20 is shown. The valve train assembly 20 includes a pair of rocker shafts 22, having an axis A-A, with attachment bolts 24 interposed therethrough and a plurality of standard rocker arm assemblies 10 and valve deactivating rocker arm assemblies 30 rotatably coupled thereto along the axial length of rocker shafts 22. Attachment bolts 24 secure rocker shafts 22 to a cylinder head assembly (not shown).

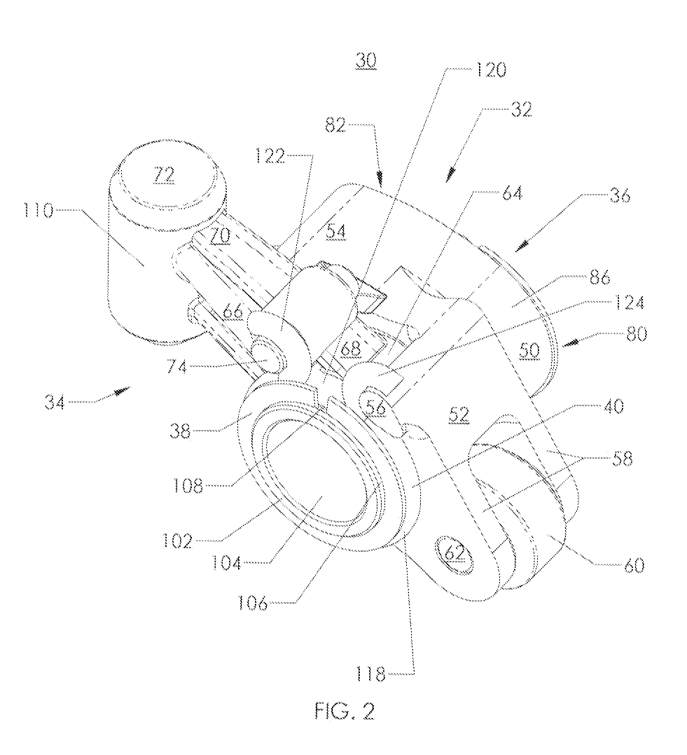

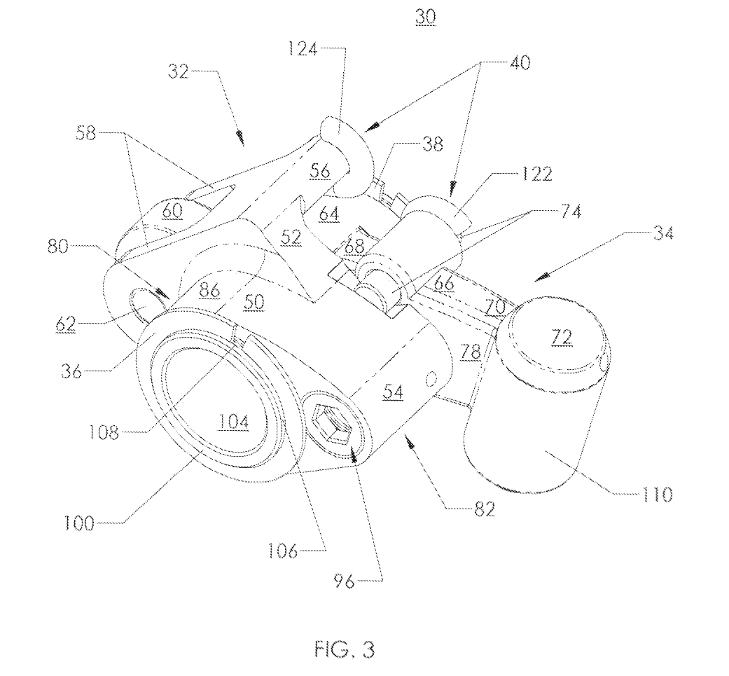

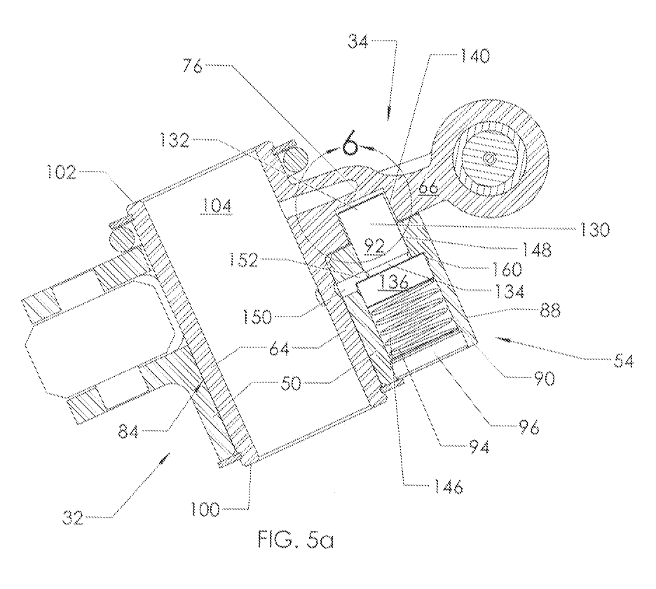

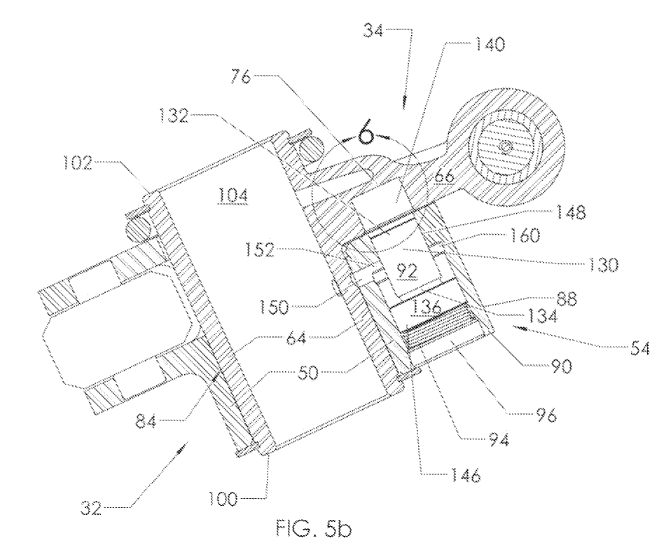

Referring to FIGS. 2-3, rocker arm assembly 30 includes a cam arm 32 having a valve arm 34 journaled therein, a cam arm retaining clip 36, a spring retaining clip 38, and an arm spring 40. Cam arm 32 includes a tubular cam body portion 50 having an arm portion 52 and a deactivation device, or deactivating portion 54 extending therefrom. Arm portion 52 includes a cam spring pin 56 extending therefrom, a bifurcated end 58 having a roller 60 rotatably coupled thereto via a roller pin 62. Roller pin 62 is interposed through both the bifurcated end 58 and the roller 60. Valve arm 34 includes a tubular valve body portion 64 having an arm portion 66 extending therefrom. Arm portion 66 includes a proximal end 68 attached to valve body portion 64 and a distal end 70 having a valve contacting portion 72 attached thereto. Arm portion 66 further includes a valve spring pin 74 extending therefrom, a lock pin aperture 76 (FIGS. 5a and 5b) formed therein, and a lock pin sliding surface 78 (FIG. 3). Cam body portion 50 is a hollow elongated cylinder that includes a first annular end 80, a second annular end 82 (FIG. 2), a generally cylindrical cam arm inner surface 84 (FIGS. 5a and 5b), and a cylindrical cam arm outer surface 86.

With specific reference to FIGS. 5a and 5b, deactivation portion 54 includes a tubular body 88, which, in one embodiment, is a hollow elongated cylinder having an end 90, attached to the cam portion 50 (FIG. 3). In one embodiment, a lock pin 92 is at least partially housed within body 88 and positioned so as to be in engagement with a return spring 94. Deactivation portion 54 includes a return spring 94 and a cap 96 secured to end 90. Cap 96 closes off body 88 and provides a surface for return spring 94 to act against. Alternately, end 90 may be provided with mounting shoulders for return spring 94 to act against, thereby eliminating the need for cap 96.

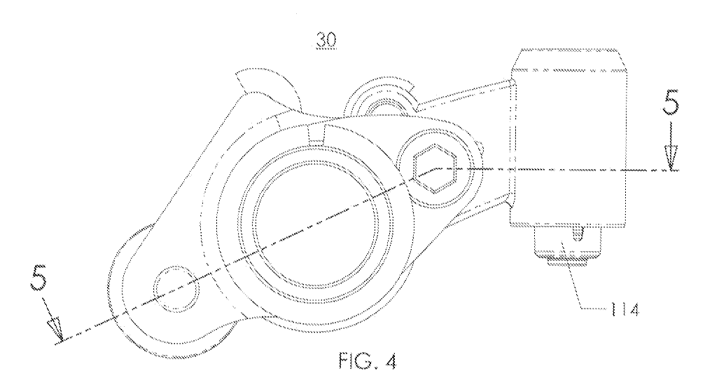

Referring again to FIGS. 2-3, the valve body portion 64 is a hollow elongated cylinder that includes a first annular end 100 (FIG. 3), a second annular end 102 (FIG. 2), a generally cylindrical valve arm inside surface 104, and a generally cylindrical valve arm outside surface 106. Valve body portion 64 also includes a pair of annular retaining grooves 108 formed in valve arm outside surface 106, adjacent the first annular end 100 and the second annular end 102, respectively. Valve contacting portion 72 includes a housing 110 that retains an hydraulic lash adjuster 114 (FIG. 4). Hydraulic lash adjuster 114 contacts the stem of a valve (not shown) for operation thereof.

As shown in FIG. 2, arm spring 40 is mounted on second annular end 102 of valve body portion 64. In one embodiment, arm spring 40 includes a curved body 118 that defines an arcuate section. Curved body 118 has an open section 120 flanked by a valve pin end 122 and a cam pin end 124. It is apparent that the arm spring may comprise a helical form (not shown) whereby arm spring hook 122 attaches to pin 74 and arm spring hook 124 attaches to a pin that would be coaxial with pin 56 but located on the other side of the rocker arm section.

Lock pin 92 is illustrated in FIGS. 5a and 5b to include a generally cylindrical plunger portion 130 having a distal end 132 and a proximal end 134 integrally connected to a generally cylindrical piston portion 136. Lock pin aperture 76 includes a cylindrical pin surface 140 formed inside arm portion 66. Tubular body 88 includes a generally cylindrical piston surface 146 that slideably engages piston portion 136, a generally cylindrical pin outlet surface 148, and an oil inlet channel 150 that intersects the piston surface 146 defining an oil port 152. Collectively, plunger portion 130, piston surface 146 and piston portion 136 form a hydraulic cavity 160 as discussed below. The clearances between cylindrical piston surface 146 and cylindrical piston portion 136, and between cylindrical plunger portion 130 and pin outlet surface 148, are sufficiently small so as to allow pressure to build within hydraulic cavity 160 when pressurized oil is supplied through oil port 152 to hydraulic cavity 160.

As best seen in FIGS. 5a and 5b, valve portion 64 of valve arm 34 is interposed through cam body portion 50 of cam arm 32 with the first annular end 100 and the second annular end 102 protruding therefrom. Thus coupled, cam arm 32 and valve arm 34 are journaled for relative rotation therebetween about axis A-A referenced in FIG. 1.

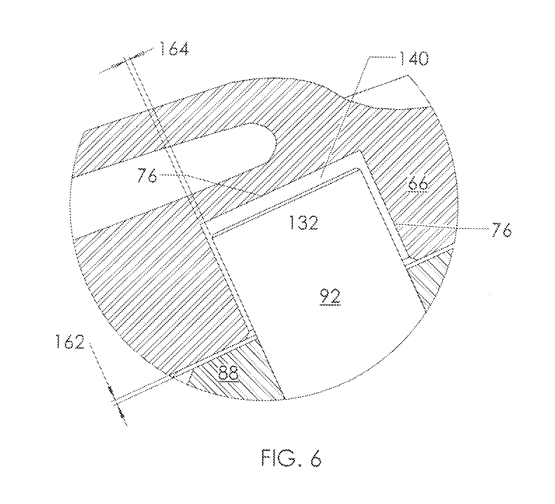

Referring again to FIGS. 2-3, arm spring 40 is superposed around second annular end 102 (FIG. 3). Valve pin end 122 of arm spring 40 is coupled to valve spring pin 74 and cam pin end 124 is coupled to cam spring pin 56. Arm spring 40 selectively biases cam spring pin 56 away from valve spring pin 74. Preferably, arm spring 40 is a partial coil spring with at least a portion thereof curved about axis A-A. Also preferably, arm spring 40 extends less than 360° about axis A-A. The cam arm retaining clip 36 is inserted into a retaining groove 108, limiting lateral clearance 162 (FIG. 6) between valve arm 34 and cam arm 32. The spring retaining clip 38 is inserted into retaining groove 108 to retain arm spring 40 on valve body portion 64.

Referring again to FIGS. 5a and 5b, lock pin 92 is positioned within tubular body 88 and in alignment with lock pin aperture 76. Lock pin 92 is moveable between an activated position (FIG. 5a) and a deactivated position (FIG. 5b). In FIGS. 5a and 6, at least the distal end 132 of lock pin 92 is circumscribed by cylindrical pin surface 140 of lock pin aperture 76. In FIG. 5b, return spring 94 is compressed between lock pin 92 and cap 96 by a force exerted by the pressure of oil contained within hydraulic cavity 160, as discussed below. In operation, lock pin 92 is in the activated position of FIG. 5a thereby releasably coupling valve arm 34 and cam arm 32 for relative rotation. Cam arm retaining clip 36 limits lateral translation between valve arm 34 and cam arm 32 along axis A-A. As a camshaft (not shown) rotates and urges against roller 60 to rotate rocker arm assembly 30 about axis A-A, valve arm 34 rotates with cam arm 32 to operate a valve (not shown).

To deactivate rocker arm assembly 30 from the activated condition, pressurized oil is introduced into hydraulic cavity 160, thereby urging lock pin 92 toward cap 96, against the biasing force of return spring 94. The existence of clearance or mechanical lash 164 (FIG. 6) between cylindrical plunger portion 130 of lock pin 92 and cylindrical pin surface 140 within lock pin aperture 76, ensures that the motion of lock pin 92 will not be impeded by friction between those surfaces, thereby ensuring smooth action. When the lock pin 92 has moved out of engagement with lock pin aperture 76, valve arm 34 is free to rotate relative to cam arm 32, thereby placing rocker arm assembly 30 in a deactivated condition shown in FIG. 5b. As the camshaft rotates further, urging roller 60, cam arm 32 rotates about axis A-A and valve arm 34 does not rotate. Since valve arm 34 does not rotate, the valve is not operated and is effectively shut down. With relative rotation of cam arm 32 and valve arm 34, arm spring 40 is deflected, thereby storing energy and inducing a relative torsion between valve arm 34 and cam arm 32. This torsion urges roller 60 to generally stay in contact with the camshaft.

To activate rocker arm assembly 30 from the deactivated condition, pressurized oil is released from hydraulic cavity 160, thereby allowing return spring 94 to urge lock pin 92 toward valve arm 34. The existence of clearance or mechanical lash 164 (FIG. 6) between cylindrical plunger portion 130 of lock pin 92 and cylindrical pin surface 140 within lock pin aperture 76 ensures that lock pin 92 may freely enter lock pin aperture 76. Depending upon the relative angular positions of valve arm 34 and cam arm 32, distal end 132 of lock pin 92 will contact either lock pin aperture 76 or lock pin sliding surface 78 (FIG. 3). When lock pin 92 contacts lock pin sliding surface 78, valve arm 34 will not rotate and arm spring 40 urges cam arm 32 to rotate as the camshaft rotates. As cam arm 32 rotates and valve arm 34 does not rotate lock pin 92 in contact with lock pin sliding surface 78, it follows a generally circular arc about axis A-A. As the camshaft rotates further, lock pin 92 will align with and engage lock pin aperture 76, thereby placing rocker arm assembly 30 in an activated condition. Thus, lock pin 92 is selectively guided into engagement with said cylindrical pin surface 140 of lock pin aperture 76 by the relative rotation of cam arm 32 and valve arm 34.

Preferably, the flow of oil into hydraulic cavity 160 is controlled by an electronic solenoid valve (not shown), although other conventional means may be utilized. Also preferably, the oil flows through the solenoid valve then through a channel (not shown) in the cylinder head on into the rocker shaft 22 and continues through the valve arm 34 into the cam arm 32 through oil inlet channel past oil port 152 and into the hydraulic cavity 160. While the deactivation portion 54 has been described herein as attached to valve arm 34, it will be appreciated that the deactivation device may be attached to cam arm 32 or other portions of valve train assembly 20 to accomplish the same purpose. While many components of valve train assembly are described as tubular or cylindrical, it is understood that at least some of these components and their complementary shaped components can be formed as a rod or in shapes other than circular to perform a similar function.

It is to be understood that the above description is intended to be illustrative and not limiting. Many embodiments will be apparent to those of skill in the art upon reading the above description. Therefore, the scope of the invention should be determined not with reference to the above description, but instead with reference to the appended claims, along with the full scope of equivalents to which such claims are entitled.

What is claimed is:

1. A rocker arm assembly having a valve deactivation device, wherein the rocker arm assembly is selectively switchable between an activated condition and a deactivated condition, the rocker arm assembly comprising:
a) a valve arm;
b) a cam arm rotatably coupled to said valve arm and wherein at least a portion of said valve arm and at least a portion of said cam arm are concentrically positioned about a common axis; and
c) a valve deactivation device coupled to said cam arm, said valve deactivation device having a lock pin housed in an opening in a mating body aligned with said lock pin that is selectively adjusted such that the clearance between the lock pin and opening in the mating body provide a dedicated fit and cooperate with a surface of said valve arm, wherein said lock pin is moveable between a deactivated position and an activated position, said activated position corresponding to said activated condition, and said deactivated position corresponding to said deactivated condition.

2. The rocker arm assembly of claim 1, further comprising an arm spring selectively coupled to said valve arm and said cam arm, wherein said arm spring opposingly biases said valve arm and said cam arm thereby inducing a relative torsion therebetween.

3. The rocker arm assembly of claim 2, wherein said arm spring includes an arcuate section, wherein said arcuate section extends less than 360° around an axis of said arcuate section.

4. The rocker arm assembly of claim 1, wherein a portion of said valve arm is interposed within at least a portion of said cam arm.

5. The rocker arm assembly of claim 1, further comprising a return spring biasing said lock pin in said activated position.

6. The rocker arm assembly of claim 1 wherein the mating body is tubular.

7. The rocker arm assembly of claim 1, wherein said valve arm and said cam arm are rotatable generally about a common axis, said common axis being defined by a rocker shaft.

8. The assembly of claim 1, wherein an axis of said locking pin selectively follows a generally circular arc about said common axis.

9. The rocker arm assembly of claim 1, wherein said cam arm includes a roller follower.

10. The rocker arm assembly of claim 1, wherein said lock pin is selectively guided into engagement with said surface of said valve arm by relative rotation of said cam arm and said valve arm.

11. The rocker arm assembly of claim 1, further comprising a lash adjuster coupled to said valve arm.

12. A rocker arm assembly having a valve deactivation device, wherein the rocker arm assembly is switchable between an activated condition and a deactivated condition, the rocker arm assembly comprising:
a) a valve arm;
b) a cam arm rotatably coupled to said valve arm, wherein said valve arm and said cam arm are rotatable generally about a common axis, said common axis being defined by a rocker shaft, and wherein at least a portion of said valve arm and at least a portion of said cam arm are concentrically positioned about said common axis; and
c) a valve deactivation device coupled to said rocker arm assembly and comprising a lock pin and an aligned tubular body having an opening to receive said lock pin and wherein the fit of the lock pin in the opening are mated to limit the clearance between said lock pin and tubular body opening.

13. The rocker arm assembly of claim 12, further comprising an arm spring selectively coupled to said valve arm and said cam arm, wherein said arm spring biases said valve arm and said cam arm for counter-rotation.

14. The rocker arm assembly of claim 13, wherein said arm spring includes an arcuate section, wherein said arcuate section extends less than 360° around an axis of said arcuate section.

15. The assembly of claim 12, wherein said cam arm includes a roller follower.

16. The assembly of claim 12, further comprising a lash adjuster.

17. The assembly of claim 12, wherein said valve deactivation device is hydraulically operated.

18. The assembly of claim 17, wherein said valve deactivation device is electronically controlled.

19. A valve deactivation device for a rocker arm assembly that is selectively switchable between an activated condition and a deactivated condition, the valve deactivation device comprising:
a) a hydraulically operated lock pin coupled to a rocker arm assembly, wherein the lock pin is housed in an opening on a mating body in alignment with said lock pin that selectively engages a surface of said rocker arm assembly to switch said rocker arm assembly between deactivated and activated conditions, wherein the lock pin is moveable between a deactivated position and an activated position, said activated position corresponding to the activated condition, and said deactivated position corresponding to the deactivated condition; and
b) a return spring biasing said lock pin in one of said deactivated position and said activated position.

20. The valve deactivation device of claim 19 wherein said valve deactivation device is electronically controlled.

21. The valve deactivation device of claim 19 further comprising a hydraulic cavity, wherein a pressurized fluid supplied to said hydraulic cavity urges said lock pin toward one of said deactivated position and said activated position.

22. The valve deactivation device of claim 21 wherein said lock pin is at least partially positioned within said hydraulic cavity.
